(19) United States
(12) Patent Application Publication
(10) Pub. No.: US 2006/0293450 A1
(43) Pub. Date: Dec. 28, 2006

(54) Polymerizable compositions and articles formed thereby and methods of formation

(76) Inventors: Clyde Spencer Hutchins, Colden, NY (US); Rolf Thomas Weberg, East Aurora, NY (US); David Gordon Halterman, Tonawanda, NY (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/165,258

(22) Filed: Jun. 23, 2005

(51) Int. Cl. C08F 8/40; C08L 63/00

(52) U.S. Cl. 525/107; 525/340

(57) ABSTRACT

A polymerizable composition comprises a monoethylenically unsaturated resin, a phosphoric acid ester, an epoxy and a free radical initiator.

### FIELD OF THE INVENTION

This invention is directed to polymerizable compositions and materials formed thereby such as solid surface materials employed as kitchen countertops and wall surfaces.

### DESCRIPTION OF RELATED ART

Solid surface materials conventionally contain solid particles embedded in a cured polymer system. The solid particles may be employed in relatively small quantities to impart properties such as fire retardation or for aesthetic considerations. In such case the cured polymer system typically is present as a major or predominant constituent of the final article with particles embedded therein. In other instances the solid particles may be present as the major or predominant constituent of the final article. In this case the cured polymer system acts as a binder for the solid particles.

Havriliak U.S. Pat. No. 3,912,773 is directed to a coating resin system which reacts via a vinyl polymerization reaction and cures via an acid-epoxide reaction.

Hayashi et al. U.S. Pat. No. 4,916,172 discloses a reaction curable composition and artificial marble obtained by molding and curing the composition. The curable composition comprises a curable component, a polymerization initiator for curing the curable component and from 30 to 90% by weight, based on the total composition, of inorganic fillers, wherein the curable component is a combination of a polyfunctional allylcarbonate monomer or its precondensate, an unsaturated polyester and a reactive diluent, or a combination of a partially cured product of at least two of such three components and the rest of such three components, if any.

Wilkinson et al. U.S. Pat. No. 6,387,985 discloses an acrylic and quartz based composition particularly suitable for use as a countertop.

A need is present for improved curable compositions.

### SUMMARY OF THE INVENTION

The present invention is directed to a polymerizable composition comprising:
(i) a monoethylenically unsaturated resin polymerizable by a free radical initiator;
(ii) a phosphoric acid ester;
(iii) an epoxy;
(iv) a free radical initiator.

With the presence of the free radical initiator, the curable composition is converted to a polymerized cured article.

### DETAILED DESCRIPTION OF THE INVENTION

A first necessary component in the polymerizable composition one or more monoethylenically unsaturated resin polymerizable by a free radical initiator. As employed herein resin means at least one of a monomer, oligomer, co-oligomer, polymer, copolymer, or a mixture thereof, including polymer-in-monomer sirups.

A preferred monoethylenically unsaturated resin is derived from an ester of acrylic or methacrylic acid. The ester can be generally derived from an alcohol having 1-20 carbon atoms. Suitable alcohols are aliphatic, cycloaliphatic or aromatic. The ester may also be substituted with groups including, but not limited to, hydroxyl, halogen, and nitro. Representative (meth)acrylate esters include methyl (meth)acrylate, ethyl (methyl)acrylate, butyl (methyl)acrylate, 2-ethylhexyl (meth)acrylate, glycidyl (meth)acrylate, cyclohexo (meth)acrylate, isobornyl (meth)acrylate, and siloxane (methyl)acrylate. Methyl methacrylate is particularly preferred.

Additional examples of monoethylenically unsaturated resins include ones with a vinyl group such as acrylonitrile, methacrylonitrile, and vinyl acetate. Additional polymerizable components in addition to the monoethylenically unsaturated monomers can be employed as is well-known in the art. Illustratively, polyethylenically unsaturated resin monomers are suitable.

A second necessary component is a phosphoric acid ester.

For purposes of illustration phosphoric acid esters include Formulas I to IV as follows:

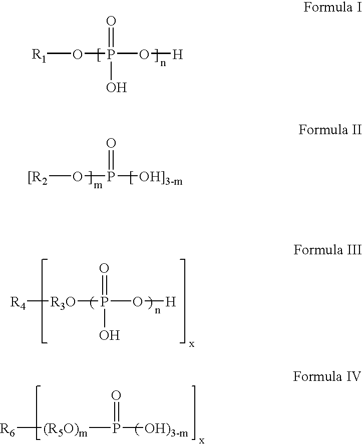

Each of R1 through R6 represents an organic moiety. For purposes of illustration concerning Formulas I and II, R1 and R2 can be aromatic, alkyl, and unsaturated alkyl moieties containing from 6 to 20 carbon atoms. Also for purposes of further illustration R1 and R2 can be an ether or polyether with 4 to 70 carbon atoms and 2 to 35 oxygen atoms.

Concerning Formulas III and IV, R3 and R5 can include aromatic, alkyl, and unsaturated alkyl moieties containing from 1 to 12 carbon atoms. Also for purposes of further illustration R3 and R5 can be an ether or polyether with 1 to 12 carbon atoms and 1 to 6 oxygen atoms, while R4 and R6 can include a polymeric moiety such as acrylic, polyester, polyether and siloxane polymer backbone.

It is understood that in the above formulas, m represents an integer of 1 or 2. The integers n and x can be 1 but include repeating integers such as for n from 1 to 7 and x from 1 to 20.

As further illustration of the scope of phosphoric acid esters are those disclosed in Hayashi et al. U.S. Pat. No. 4,916,172 of the structure: 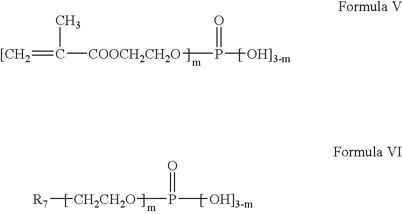
wherein R7 is an alkyl group having from 8 to 12 carbon atoms and m is an integer of 1 or 2.

A third necessary component is an epoxy. Any one or more of a number of substances with an epoxide group present in the molecule may be employed as the epoxy. Examples of such substances are bisphenol A epoxy; diepoxides; triepoxides; α,β-monoethylenically unsaturated epoxides such as glycidyl methacrylate; an oligomer bearing multiple pendant epoxide groups; a polymer bearing multiple epoxide groups; or combinations thereof. A preferred epoxide is a diepoxide. The diepoxide may be aliphatic, cycloaliphatic, mixed aliphatic and cycloaliphatic and aromatic. The diepoxide may be substituted with halogen, alkyl aryl or sulfur radical. Useful diepoxides are disclosed in Havriliak U.S. Pat. No. 3,912,773. A preferred diepoxide is 3,4-epoxycyclohexylmethyl-3,4-epoxycyclohexane. A further preferred diepoxide is diglycidyl ether of bisphenol A.

A fourth necessary component is a free radical initiator. Either a chemically-activated thermal initiation or a purely temperature-driven thermal initiation to cure the polymerizable components may be employed herein. Both cure systems are well-known in the art. Azo type initiators that thermally decompose may be used and include Vazo® 52, Vazo® 64 and Vazo® 67 (registered trademark of E. I. du Pont de Nemours & Co.).

The amounts of the four components in the polymerizable composition generally can vary within wide percentages. For purposes of illustration on the basis of these four components (by weight) the monoethylenically unsaturated resin may be from 40 to 80 parts, the phosphoric acid ester may be from 0.1 to 5 parts, the epoxy from 0.1 to 50 parts and the free radical initiator from 0.01 to 2.0 parts. Illustratively, a molar ratio of phosphoric acid ester to epoxy is in a range from 1:10 to 10:1. Additional additives may be introduced into the polymerizable composition which is well-known in the art. The composition can be cast or molded followed by curing to solidify the composition.

The following examples are included as representative of the embodiments of the present invention. The percentages are by weight, and the temperatures are in centigrade, unless otherwise noted. Grams are represented by “g”.

### EXAMPLE 1

A 200 mL reaction kettle (13×17 cm) fitted with a neoprene O-Ring was assembled with a reactor top having ports for a temperature probe, air-driven stirrer, rubber septum and an Allihn® type reflux condenser. The following ingredients were sequentially weighed into the reactor:

| | | |
|---|---|---|
| Luperco PMA-25 (t-Butyl Peroxymaleic Acid Paste; | 15.89 | g |
| AtoFina) | | |
| Aerosol-OT-S (Sodium Dioctyl Sulfosuccinate; Cytec) | 2.36 | g |
| TRIM (Trimethylolpropane Trimethacrylate; Sartomer) | 1.50 | g |
| Prepolymer Sirup (35% Solution of Bisphenol A | 659.02 | g |
| Diglycidyl Ether; Araldite ® GT6063, Ciba-Giegy | | |
| in methyl methacrylate monomer) | | |
| Zelec ® PH (85% phosphated hydroxyethyl methacrylate | 10.71 | g |
| dissolved in n-Butyl Methacrylate monomer; Stepan) | | |

After mixing these ingredients using a high-speed disperser blade (60 mm Diameter—INDCO Cowles Type) at 200 revolutions per minute (rpm) for one minute at room temperature, 1050 g of Aluminum Trihydroxide; Alcan WH311 mineral filler was added portionwise over a two-minute interval. During the portionwise addition of the filler the revolutions per minute (rpm) of the blade was incrementally increased to about 2000 rpm.

After the filler addition was complete, the blade speed was maintained for 10 minutes. After this time, the mix was re-weighed and about 5.0 g of methyl methacylic monomer was added replenishing methyl methacrylate lost due to evaporation. The mix was then evacuated (reflux condenser cooled to −10C) at 75 Torr (about 27 inches of Hg) for two minutes with 1000 rpm stirring (3 foot—four blade prop). The vacuum was released with air then a 90 g aliquot was withdrawn for viscosity measurement. The Brookfield viscosity (DVII+; spindle #T-D; 30 rpm) was 520 cps.

The mix was re-evacuated to 125 Torr (about 25 inches of mercury) with stirring (1000 rpm; four-blade prop), then gently warmed to 41C using a waterbath. Mixing rpm was increased to 1500 rpm and the following ingredients were sequentially injected in rapid succession using a syringe through the septum:

| | |
|---|---|
| De-mineralized water | 1.61 g |
| Calcium Hydroxide Dispersion (54% in | 6.43 g |
| butyl methylacrylate monomer) | |
| GDMA (Glycol Dimercaptoacetate) | 2.50 g |

The addition of the GDMA was considered as “Time Zero”. The slurry was mixed at 1500 rpm at 41C for about 10 sec. Mixing was discontinued and the vacuum released in rapid succession. The activated mix was gently swirled (to avoid skinning) and poured into a 14.7 mm sheet-casting mold within a one-minute interval. The time required to achieve a peak temperature of 117C was 11.4 minutes. After the polymerization was complete (as indicated by a drop in temperature within the mold), the hardened, polymerized composite plaque was removed from the mold and heated in an oven at 125C for about one hour. After cooling to room temperature, the plaque was sanded and finished to a final thickness of 12.7 mm.

### EXAMPLE 2

A 200 mL reaction kettle (13×17 cm) fitted with a neoprene O-Ring was assembled with a reactor top having ports for a temperature probe, air-driven stirrer, rubber septum and an Allihn® type reflux condenser. The reaction kettle was charged with 492.6 g of Bisphenol A Diglycidyl Ether (Araldite® GT6063, Ciba-Giegy) and 492.6 g of MMA monomer. This mixture was stirred at room temperature for 2 hr. 14.8 g of PEMA (phosphated hydroxyethyl methacrylate) was added to the clear solution and the resulting mixture was heated to 1000C for 30 minutes. After cooling the resulting sirup to room temperature, the following ingredients were sequentially added to the reactor with stirring:

| | | |
|---|---|---|
| PMA-25 (t-Butyl Peroxymaleic Acid Paste) | 18.95 | g |
| Aerosol-OT | 2.81 | g |
| n-Butyl acrylate (nBA) monomer | 39.4 | g |

After mixing these ingredients using a high-speed disperser blade (60 mm Diameter—INDCO Cowles Type) at 200 rpm for one minute at room temperature, 680.0 g of Aluminum Trihydroxide; Alcan VXH-100 filler was added portionwise over a two-minute interval. During the portionwise addition of the filler, the rpm of the blade was incrementally increased to about 2000 rpm.

After the filler addition was complete, the blade speed was maintained for 10 minutes. After this time, the mix was re-weighed and about 5.0 g of methyl methacrylate monomer (methyl methacrylate) was added replenishing methyl methacrylate lost due to evaporation. The mix was then evacuated (reflux condenser cooled to −10C) at 75 Torr (about 27 inches of Hg) for two minutes with −1000 rpm stirring (3′-four blade prop). The vacuum was released with air then a 90 g aliquot was withdrawn for viscosity measurement. The Brookfield viscosity (DVII+; spindle #T-D; 30 rpm) was 600 cps.

The mix was re-evacuated to 125 Torr (about 25 inches of Hg) with stirring (1000 rpm; four-blade prop), then gently warmed to 35C using a waterbath. Mixing rpm was increased to 1500 rpm and the following ingredients were sequentially injected in rapid succession using a syringe through the septum:

| | |
|---|---|
| De-mineralized water | 1.92 g |
| 54% Calcium Hydroxide Dispersion | 7.58 g |
| (in Butyl Methacrylate monomer) | |
| GDMA (Glycol Dimercaptoacetate) | 2.98 g |

The addition of the GDMA was considered as “Time Zero”. The slurry was mixed at 1500 rpm at 35C for about 10 sec. Mixing was discontinued and the vacuum released in rapid succession. The activated mix was gently swirled (to avoid skinning) and poured into a 14.7 mm sheet-casting mold within a one-minute interval. The time required to achieve a peak temperature of 129C was 4.4 minutes. After the polymerization was complete (as indicated by a drop in temperature within the mold), the hardened, polymerized composite plaque was removed from the mold and heated in an oven at 125C for about one hour. After cooling to room temperature, the translucent plaque was sanded and finished to a final thickness of 12.7 mm.

### EXAMPLE 3

A 200 mL reaction kettle (13×17 cm) fitted with a neoprene O-Ring was assembled with a reactor top having ports for a temperature probe, air-driven stirrer, rubber septum and an Allihn® type reflux condenser. The reaction kettle was charged with 671.6 g of Bisphenol A Diglycidyl Ether sirup. The sirup was prepared by dissolving 268.6 g of (Araldite® GT6063, Ciba-Giegy) in a mixture of 322.4 g of Methyl Methacrylate (MMA) monomer and 80.6 g of n-Butyl Methacrylate (BMA) monomer. The following ingredients were sequentially added to the reactor with gentle stirring:

| | | |
|---|---|---|
| Luperco PMA-25 (t-Butyl Peroxymaleic Acid Paste; | 15.11 | g |
| AtoFina) | | |
| Aerosol-OT-S (Sodium Dioctyl Sulfosuccinate; Cytec) | 2.22 | g |
| TRIM (Trimethylolpropane Trimethacrylate; Sartomer) | 4.03 | g |
| Zelec ® PH (85% phosphated hydroxyethyl methacrylate | 10.71 | g |
| dissolved in n-Butyl Methacrylate (BMA) monomer; Stepan) | | |

After mixing these ingredients using a high-speed disperser blade (60 mm Diameter—INDCO Cowles Type) at 200 rpm for one minute at 25C, 1080.0 g of Aluminum Trihydroxide; Alcan WH311 mineral filler was added portionwise over a two-minute interval. During the portionwise addition of the filler, the rpm of the blade was incrementally increased to about 2000 rpm.

After the filler addition was complete, the blade speed was maintained for 10 minutes. After this time, the mix was re-weighed and about 5.0 g of methyl methacrylate monomer was added replenishing methyl methacrylate lost due to evaporation. The mix was then evacuated (reflux condenser cooled to −10C) at 75 Torr (about 27 inches of Hg) for two minutes with 1000 rpm stirring (3′—four blade prop). The vacuum was released with air, and a 90 g aliquot was withdrawn for viscosity measurement. The Brookfield viscosity (DVII+; spindle #T-D; 30 rpm) was 960 cps.

The mix was re-evacuated to 125 Torr (about 25 inches of Hg) with stirring (1000 rpm; four-blade prop), then gently warmed to 35C using a waterbath. Mixing rpm was increased to 1500 rpm and the following ingredients were sequentially injected in rapid succession using a 5 cc syringe through the septum:

| | | |
|---|---|---|
| De-mineralized water | 1.51 | g |
| Calcium Hydroxide Dispersion (54% in BMA) | 15.11 | g |
| GDMA (Glycol Dimercaptoacetate) | 2.37 | g |

The addition of the GDMA was considered as “Time Zero”. The slurry was mixed at 1500 rpm at 35C for about 10 sec. Mixing was discontinued and the vacuum released in rapid succession. The activated mix was gently swirled (to avoid skinning) and poured into a 14.7 mm sheet-casting mold within a one-minute interval. The time required to achieve a peak temperature of 108C was 5.5 minutes. After the polymerization was complete (as indicated by a drop in temperature within the mold), the hardened, polymerized composite plaque was removed from the mold and heated in an oven at 125C for about one hour. After cooling to room temperature, the translucent plaque was sanded and finished to a final thickness of 12.7 mm.

### EXAMPLE 4

A 200 mL reaction kettle (13 cm×17 cm) fitted with a neoprene O-Ring was assembled with the reactor top having ports for a temperature probe, air-driven stirrer, rubber septum and an Allihn®-type reflux condenser. The reactor was charged with 772.6 g of a prepolymer sirup which was prepared by dissolving 309 g of Bisphenol A Diglycidyl Ether (Araldite® GT6063, Ciba-Giegy) in 463.6 g of methyl methacrylate monomer.

The following ingredients were then sequentially weighed into the reactor containing the sirup:

| | | |
|---|---|---|
| Phosphated Hydroxyethyl methacrylate monomer | 23.18 | g |
| (PEMA, Johoku) | | |
| Aerosol-OT-S (Sodium Dioctyl Sulfosuccinate; Cytec) | 2.55 | g |
| Lupersol ® 10M75 (t-Butyl Peroxyneodecanoate; AtoFina) | 1.39 | g |
| Vazo ® 67 (DuPont) | 0.28 | g |

After mixing these ingredients using a high-speed disperser blade (60 mm Diameter—INDCO Cowles Type) at 200 rpm for one minute at room temperature, 800 g of Aluminum Trihydroxide; Alcan WH311 mineral filler was added portionwise over a two-minute interval. During the portionwise addition of the filler, the rpm of the blade was incrementally increased to about 2000 rpm.

After the filler addition was complete, the blade speed was maintained for 10 minutes. After this time, the mix was re-weighed and about 5.0 g of methyl methacrylate monomer was added replenishing methyl methacrylate lost due to evaporation. The mix was then evacuated (reflux condenser cooled to −10C) at 75 Torr (about 27 inches of Hg) for five minutes with 1000 rpm stirring (3 foot—four blade prop). The vacuum was released with air, and then a 90 g aliquot was withdrawn for viscosity measurement. The Brookfield viscosity (DVII+spindle #T-D; 30 rpm) was 590 cps.

The mix was poured into a casting mold constructed from two stainless metal plates (25.4 cm×25.4 cm×1.0 mm) separated by a Silastic® gasket (14.7 mm thickness). Each of the metal plates was coated with a polyvinyl alcohol release film. The casting mold was assembled and held together using spring clamps. After bleeding a small amount of air from the cell, the sealed cell was submerged vertically in a 60C waterbath. Progress of the polymerization was monitored using a thermocouple inserted into the casting cell through the gasket. The time required to achieve a peak temperature of about 110C was 25 minutes. Twenty minutes after the maximum temperature was attained, the casting cell was removed from the waterbath and placed in a 120C circulating hot air oven for sixty minutes. After removing the cell from the hot air oven, the hardened, polymerized composite plaque was easily separated from the metal casting mold when the temperature of the composite had dropped below 50C (about one hour).

### EXAMPLE 5

A 2000 mL reaction kettle (13 cm×17 cm) fitted with a neoprene O-Ring was assembled with the reactor top having ports for a temperature probe, air-driven stirrer, rubber septum and an Allihn®-type reflux condenser. The reactor was charged with 824.1 g of a prepolymer sirup which was prepared by dissolving 412.1 g of Bisphenol A Diglycidyl Ether (Araldite® GT6063, Ciba-Giegy) in 412.0 g of methyl methacrylate monomer.

The following ingredients were then sequentially weighed into the reactor containing the sirup:

| | | |
|---|---|---|
| Zelec ® PH (85% phosphated hydroxyethyl methacrylate | 12.36 | g |
| dissolved in n-Butyl Methacrylate (BMA) monomer; Stepan) | | |
| Aerosol-OT-S (Sodium Dioctyl Sulfosuccinate; Cytec) | 2.06 | g |
| Lupersol ® 10M75 (t-Butyl Peroxyneodecanoate; AtoFina) | 1.24 | g |
| Vazo ® 67 (DuPont) | 0.25 | g |

After mixing these ingredients using a high-speed disperser blade (60 mm Diameter—INDCO Cowles Type) at 200 rpm for one minute at room temperature, 360 g of Aluminum Trihydroxide; Alcan WH311 mineral filler was added portionwise over a two-minute interval. During the portionwise addition of the ATH filler, the rpm of the blade was incrementally increased to about 2000 rpm.

After the filler addition was complete, the blade speed was maintained for 10 minutes. After this time, the mix was re-weighed and about 5.0 g of methyl methacrylate monomer (methyl methacrylate) was added replenishing methyl methacrylate lost due to evaporation. The mix was then evacuated (reflux condenser cooled to −10C) at 75 Torr (about 27 inches of Hg) for five minutes with 1000 rpm stirring (3′—four blade prop). The vacuum was released with air, and then a 90 g aliquot was withdrawn for viscosity measurement. The Brookfield viscosity (DVII+spindle #T-D; 30 rpm) was 550 cps.

The mix was poured into a casting mold constructed from two stainless metal plates (25.4 cm×25.4 cm×1.0 mm) separated by a Silastic® gasket (14.7 mm thickness). Each of the metal plates was coated with a PVA release film. The casting mold was assembled and held together using spring clamps. After bleeding a small amount of air from the cell, the sealed cell was submerged vertically in a 60C waterbath. Progress of the polymerization was monitored using a thermocouple inserted into the casting cell through the gasket. The time required to achieve a peak temperature of about 92C was 29 minutes. Twenty minutes after the maximum temperature was attained, the casting cell was removed from the waterbath and placed in a 125C circulating hot air oven for sixty minutes. After removing the cell from the hot air oven, the hardened, polymerized composite plaque was easily separated from the metal casting mold when the temperature of the composite had dropped below 50C (about one hour).

### EXAMPLE 6

A 2000 mL reaction kettle (13×17 cm) fitted with a Neoprene O-Ring was assembled with a reactor top having ports for a temperature probe, air-driven stirrer, rubber septum and an Allihn® type reflux condenser. The following ingredients were sequentially weighed into the reactor:

| | | |
|---|---|---|
| Luperco PMA-25 (t-Butyl Peroxymaleic Acid Paste; | 15.87 | g |
| AtoFina) | | |
| Aerosol-OT-S (Sodium Dioctyl Sulfosuccinate; Cytec) | 2.35 | g |
| TRIM (Trimethylolpropane Trimethacrylate; Sartomer) | 1.50 | g |
| MMA (Methyl Methacrylate; Lucite ® International) | 427.7 | g |
| 3,4-Epoxycyclohexylmethyl-3,4-epoxycyclohexane | 230.3 | g |
| carboxylate (ERL-4221; Dow Chemical) | | |
| Zelec ® PH (85% phosphated hydroxylethyl | 10.69 | g |
| methacrylate dissolved in n-Butyl Methacrylate | | |
| (BMA) monomer; Stepan) | | |

After mixing these ingredients using a High Speed Disperser (HSD) Blade (60 mm Diameter—INDCO Cowles Type) at 200 rpm for one minute at room temperature, 1050 g of ATH (Aluminum Trihydroxide; Alcan WH31 1) mineral filler was added portionwise over a two minute interval. During the portionwise addition of the ATH filler, the rpm of the HSD was incrementally increased to about 2000 rpm.

After the ATH filler addition was complete, the HSD speed was maintained for 10 minutes. After this time, the mix was re-weighed and 5.0 g of MMA monomer (methyl methacrylate) was added replenishing MMA lost due to evaporation. The mix was re-evacuated to 125 Torr (about 25 inches of Hg) with stirring (1000 rpm; four-blade prop), then gently warmed to 41C using a waterbath over a five minute interval. Mixing rpm was increased to 1500 rpm and the following ingredients were sequentially injected in rapid succession employing a syringe thru the septum:

| | |
|---|---|
| De-mineralized water | 1.45 g |
| Calcium Hydroxide Dispersion (54% in BMA) | 7.70 g |
| GDMA (Glycol Dimercaptoacetate) | 2.49 g |

The addition of the GDMA was considered as “Time Zero”. The slurry was mixed at 1500 rpm at 41C for about 10 sec. Mixing was discontinued and the vacuum released in rapid succession. The activated mix was gently swirled (to avoid skinning) and poured into a 14.7 mm sheet casting mold within a one-minute interval. The time required to achieve a peak temperature of 102C was 19.3 minutes. After the polymerization was complete (as indicated by a drop in temperature within the mold), the hardened, polymerized composite plaque was removed from the mold and heated in an oven at 125C for about one hour. After cooling to room temperature, the plaque was sanded and finished to a final thickness of 12.7 mm.

What is claimed is:

1. A polymerizable composition comprising:
(i) a monoethylenically unsaturated resin polymerizable by a free radical initiator;
(ii) a phosphoric acid ester;
(iii) an epoxy;
(iv) a free radical initiator.

2. The composition of claim 1 wherein the resin comprises a polyester.

3. The composition of claim 1 wherein the resin comprises an acrylate.

4. The composition of claim 3 wherein the acrylate is methyl methacrylate.

5. The composition of claim 1 wherein on the basis by weight of (i), (ii), (iii) and (iv), (i) is present in a range from 40 to 80 parts, (ii) is present in a range from 0.1 to 5 parts, (iii) is present in a range from 0.1 to 50 parts, (iv) is present in a range from 0.1 to 2.0 parts.

6. The composition of claim 1 wherein the molar ratio of phosphoric acid ester to epoxy is in a range from 1:10 to 10:1.

7. A polymerized article formed by the polymerizable composition of claim 1.

8. The polymerized article of claim 7 in the form of a countertop.

9. A method for curing a polymerizable composition comprising:
(a) mixing a composition comprised of:
(i) a monoethylenically unsaturated resin polymerizable by a free radical initiator;
(ii) a phosphoric acid ester;
(iii) an epoxy;
(iv) a free radical initiator.
(b) casting or molding the composition.
(c) curing the composition.
